(19) United States
(12) Patent Application Publication
(10) Pub. No.: US 2026/0084924 A1
(43) Pub. Date: Mar. 26, 2026

(54) FINGERPRINT ALERTS FOR ELEVATORS

(71) Applicant: TK ELEVATOR INNOVATION AND OPERATIONS GMBH, Düsseldorf (DE)

(72) Inventor: Christian Jung, Ratingen (DE)

(73) Assignee: TK ELEVATOR INNOVATION AND OPERATIONS GMBH, Düsseldorf (DE)

(21) Appl. No.: 19/114,271

(22) PCT Filed: Oct. 4, 2023
(86) PCT No.: PCT/EP2023/077452

§ 371 Date: Mar. 21, 2025

Related U.S. Application Data
(60) Provisional application No. 63/378,630, filed on Oct. 6, 2022.

(51) Int. Cl. B66B 5/00; B66B 1/34

(52) U.S. Cl. CPC B66B 5/0025; B66B 1/3461; B66B 5/0031

(57) ABSTRACT

Embodiments of the present disclosure are directed to a computing device comprising one or more processors configured to receive elevator data comprising a series of actions performed by an elevator during a predetermined period of time, determine whether the elevator data satisfies one or more error conditions, and upon determination that the elevator data satisfies one or more of the error conditions, transmit an alert to a technician associated with the elevator.

### CROSS-REFERENCE TO RELATED APPLICATION

This application claims the benefit of and priority to U.S. Application Ser. No. 63/378,630 filed Oct. 6, 2022, and entitled “Fingerprint Alerts”, the entire contents of which are incorporated by reference in the present disclosure.

### TECHNICAL FIELD

The present disclosure generally relates to elevator systems, and more particularly, to fingerprint alerts for elevators.

### BACKGROUND

An elevator may output a large amount of data related to its operation. It may be desirable to identify elevator errors based on this data. Accordingly, a need exists for fingerprint alerts for elevators.

### SUMMARY

In one embodiment, a computing devices includes one or more processors configured to receive elevator data comprising a series of actions performed by an elevator car during a predetermined period of time, determine whether the elevator data satisfies one or more error conditions, and upon determination that the elevator data satisfies one or more of the error conditions, transmit an alert to a technician associated with the elevator.

In another embodiment, a method may include receiving elevator data comprising a series of actions performed by an elevator car during a predetermined period of time, determining whether the elevator data satisfies one or more error conditions, and upon determination that the elevator data satisfies one or more of the error conditions, transmitting an alert to a technician associated with the elevator.

In another embodiment, a system may include an elevator assembly and a remote computing device. The elevator assembly may include an elevator car, an elevator controller to control operation of the elevator car, and a transceiver to transmit elevator data including a series of actions performed by the elevator car during a predetermined period of time to the remote computing device. The remote computing device may include one or more processors configured to receive the elevator data, determine whether the elevator data satisfies one or more error conditions, and upon determination that the elevator data satisfies one or more of the error conditions, transmit an alert to a technician associated with the elevator assembly.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

FIG. 1A schematically depicts a first aspect of an example elevator assembly schematic, according to one or more embodiments shown and described herein;

FIG. 1B schematically depicts a second aspect of an example elevator assembly schematic, according to one or more embodiments shown and described herein;

FIG. 2 depicts fingerprint alert system according to one or more embodiments shown and described herein;

FIG. 3 schematically depicts an example remote computing device, according to one or more embodiments shown and described herein; and

FIG. 4 depicts a flow chart of an example method for operating the remote computing device of FIG. 3, according to one or more embodiments shown and described herein.

### DETAILED DESCRIPTION

Embodiments of the present disclosure are directed to fingerprint alerts for elevators. In embodiments, an elevator system may output data associated with its operation. For example, an elevator system may output data indicating when an elevator car is called to a particular floor, when elevator doors open and close, a speed of the elevator doors opening and closing, when an elevator car moves between floors, a speed of the elevator car moving, and the like. The elevator system may also output an error code when one or more errors are detected by sensors or other hardware that are part of an elevator system.

While an error code may indicate a specific error that has occurred in the elevator system, there may be other errors that occur in the elevator system that may not be readily identified by a specific error code. However, specific patterns of behavior by the elevator car may indicate that an error has occurred with respect to the elevator car. As such, in embodiments, a plurality of elevator alert fingerprints are identified for elevator operation. An elevator alert fingerprint (which may be referred to herein as a fingerprint or an error condition) may indicate a particular error associated with an elevator system, the elevator car, or elevator operation. In particular, a fingerprint may include data associated with elevator operation (e.g., statistics related to elevator operation or a specific sequence of elevator actions) that indicates a particular error. As such, in embodiments, data output by the elevator system may be compared to one or more fingerprints associated with different errors to determine whether the elevator car, or the elevator system, is experiencing a particular error. As such, elevator errors or conditions may be identified based on elevator behavior even in the absence of a specific error code being output by the elevator.

The phrase “communicatively coupled” is used herein to describe the interconnectivity of various components of the monitoring system for elevator assemblies and means that the components are connected either through wires, optical fibers, or wirelessly such that electrical, optical, data, and/or electromagnetic signals may be exchanged between the components. It should be understood that other means of connecting the various components of the system not specifically described herein are included without departing from the scope of the present disclosure.

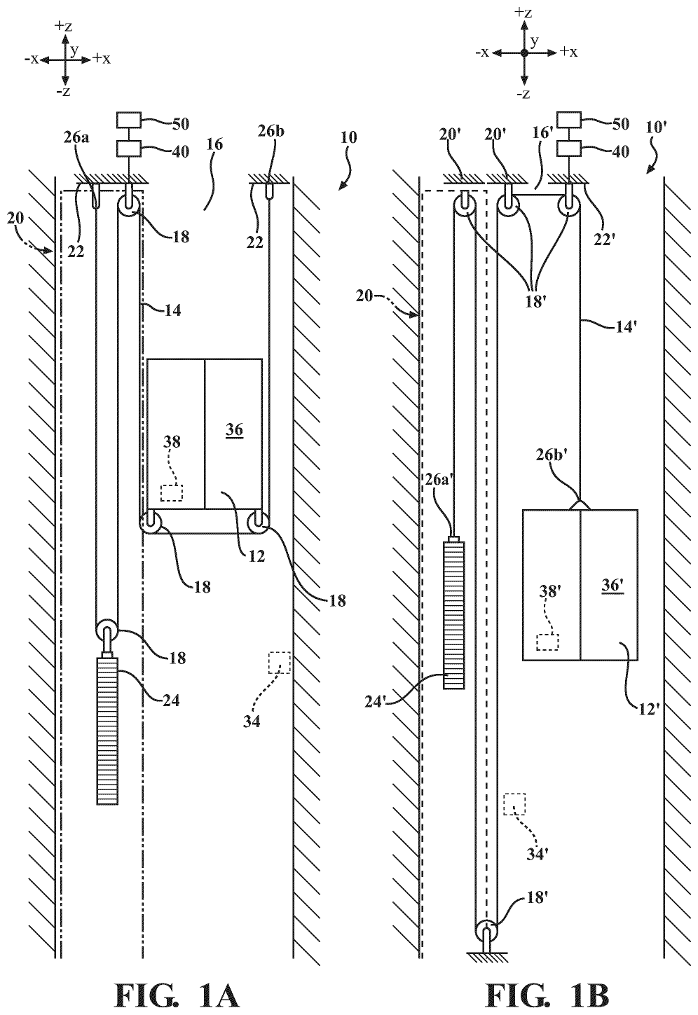

Referring now to the drawings, FIG. 1A depicts an elevator assembly schematic that illustrates various components for a first aspect of an example elevator assembly 10. In this aspect, the example elevator assembly 10 may include an elevator cab 12, a plurality of elevator hoisting members 14 illustrated for schematic reasons as a single suspension member and herein referred to as hoisting members, a hoistway 16 or elevator shaft, a plurality of sheaves 18, an example frame 20, and a plurality of weights 24 that act as a counterweight to the elevator cab 12. The plurality of weights 24 move within the example frame 20 in the system vertical direction (i.e., in the +/−Z direction). The example frame 20 may be an elevator frame, a counterweight elevator frame, and/or the like, as discussed in greater detail herein. The plurality of elevator hoisting members 14 include a distal end 26a and a proximate end 26b. As used herein, the elevator cab 12 may be referred to as an elevator car.

Further, in this aspect, as illustrated and without limitation, the example frame 20 includes two sheaves of the plurality of sheaves 18. For example, one sheave is fixedly mounted to an upper portion of the example frame 20 positioned in an upper portion of the hoistway 16 above the elevator cab 12 in a vertical direction (i.e., in the +/−Z direction) and another sheave moves with the weights 24 as the elevator cab 12 moves between various landings. This is non-limiting, and any number of the plurality of sheaves 18 may be mounted anywhere within the hoistway 16 and there may be more than or less than the two sheaves illustrated as being in the example frame 20.

At least one of the plurality of sheaves 18 within the hoistway 16 may include a motor such that the sheave is a traction sheave capable of driving the plurality of elevator hoisting members 14 through a plurality of lengths between the elevator cab 12 and the traction sheave. Further, the plurality of sheaves 18 may further include a plurality of idler sheaves that may also be mounted at various positions in the hoistway 16, and, in this aspect, are also coupled to the elevator cab 12. Idler sheaves are passive (they do not drive the elevator hoisting members 14, but rather guide or route the plurality of elevator hoisting members 14) and form a contact point, or engagement point, with the elevator cab 12. The plurality of elevator hoisting members 14 and the plurality of sheaves 18 move the elevator cab 12 between a plurality of positions within the hoistway 16 including to a plurality of landings. The plurality of sheaves 18 may include any combination of traction type sheaves and idler type sheaves.

The elevator cab 12 may include at least one elevator door 36 that is configured to open and close at particular or predetermined landings. Further, in some embodiments, the elevator cab 12 may include one or more sensors 38 configured to sense, detect, and/or transmit data respective to the elevator cab 12. For example, the one or more sensors 38 may transmit an elevator door position, a position of the elevator cab 12 within the hoistway 16, a door trip, and the like, as discussed in greater detail herein

A plurality of additional sensors 34 may be positioned within the hoistway 16 and configured to monitor the operating conditions of the elevator cab 12 and other operating conditions of the elevator assembly 10. The elevator assembly 10 may also include other sensors that may detect operational parameters associated with the elevator cab 12 and other components of the elevator assembly 10. In some examples, sensors may detect errors in operation of the elevator cab 12, temperature of the hoistway 16 and the like.

As illustrated in FIG. 1A, the elevator assembly 10 is an underslung system, with the idler sheaves positioned on a bottom surface of the elevator cab 12. Each of the plurality of elevator hoisting members 14 may be movably coupled to the traction sheave and a portion of the plurality of elevator hoisting members 14 may be coupled to the bottom surface of the elevator cab 12 to suspend the elevator cab 12 via the idler sheaves. As such, the elevator hoisting members 14 pass under the elevator cab 12 on a bottom of the elevator cab 12 via the idler sheaves, and are coupled at the top of the hoistway 16 under tension to various structures, such as to the example frame 20, a plurality of rail caps 22, and/or the like. For example, the proximate end 26b of the plurality of elevator hoisting members 14 may be fixedly coupled to the rail caps 22 and the movably coupled portion of the plurality of elevator hoisting members 14 are under tension to move the elevator cab 12 between various landings. The example frame 20 may include a dead end hitch, at least one of the plurality of rail caps 22, or other structural components.

As illustrated in FIG. 1A, the elevator assembly 10 may include an elevator controller 40 and network interface hardware 50. The elevator controller 40 may receive data from the elevator cab 12, other elevator components (e.g., each of the plurality of sheaves 18, and the like) and may control operation of the elevator assembly 10. For example, the elevator controller 40 may receive data (e.g., from the plurality of additional sensors 34, the one or more sensors 38, and the like) regarding opening and closing of the at least one elevator door 36 of the elevator cab 12, speeds of the opening and closing of the at least one elevator door 36 of the elevator cab 12, data regarding movement of the elevator cab 12 between floors, speeds of the elevator cab 12 moving between different floors, and the like. The elevator controller 40 may also receive data regarding errors detected by various sensors (e.g., from the plurality of additional sensors 34, the one or more sensors 38, and the like) of the elevator assembly 10. The elevator controller 40 may also receive data associated with elevator calls (e.g., when an elevator passenger pushes an elevator button to call the elevator cab 12 to a particular floor). In other examples, the elevator controller 40 may receive other data from the elevator cab 12 and/or other components of the elevator assembly 10. The elevator controller 40 may also control operation and movement of the elevator cab 12. The elevator controller 40 may also receive control signals or data from components remote to the elevator assembly 10.

The network interface hardware 50 may be communicatively coupled to the elevator controller 40. Accordingly, the network interface hardware 50 can include a communication transceiver for sending and/or receiving any wired or wireless communication. For example, the network interface hardware 50 may include an antenna, a modem, LAN port, Wi-Fi card, WiMax card, mobile communications hardware, near-field communication hardware, satellite communication hardware and/or any wired or wireless hardware for communicating with other networks and/or devices. The network interface hardware 50 may receive data about the elevator assembly 10 captured by the elevator controller 40. The network interface hardware 50 may also be communicatively coupled to a remote computing device, as discussed in further detail below.

Referring now to FIG. 1B, a schematic illustrating various components for a second aspect of an example elevator assembly 10′ is depicted. It should be appreciated that in the discussion herein, the elevator assembly 10, and components thereof, may refer to either elevator assembly 10, 10′. In this aspect, the elevator assembly 10′ may include an elevator cab 12′, a plurality of elevator hoisting members 14′ illustrated for schematic reasons as a single suspension member, a hoistway 16′ or elevator shaft, a plurality of sheaves 18′, such as traction sheaves and/or idler sheaves, an example grounded frame 20′, and a plurality of weights 24′ that move within the example frame 20′ in the system vertical direction (i.e., in the +/−Z direction). In this aspect, the plurality of elevator hoisting members 14′ extend a length between the weights 24′ and the elevator cab 12′. Further, in this aspect, at least one of the plurality of sheaves 18′ is a traction sheave, which, for example, may be mounted to a lower surface of the hoistway 16′. This is non-limiting, and the traction sheave of the plurality of sheaves 18′ may be mounted anywhere within the hoistway 16′ and the plurality of sheaves 18′ may include a plurality of idler sheaves and at least one traction sheave. It should be appreciated that the traction sheave may include a motor such that at least one of the plurality of sheaves 18′ is a device to drive the plurality of elevator hoisting members 14′ through a plurality of lengths with respect to the length between the traction sheave and the contact point of the elevator cab 12′. The idler sheaves may also be mounted at various positions in the hoistway 16′ including within the example frame 20′. The idler sheaves are passive (they do not drive the plurality of elevator hoisting members 14′ but rather guide or route the plurality of elevator hoisting members 14′). The plurality of elevator hoisting members 14′ are coupled to the elevator cab 12′ to form the contact point. The elevator assembly 10′ may also include the elevator controller 40 and the network interface hardware 50.

It should be appreciated that the illustrated schematics of FIGS. 1A-1B are merely examples and that the plurality of elevator hoisting members 14 routing may vary significantly or slightly from these illustrated schematics. For example, there may be several idler sheaves positioned in the hoistway 16 between the traction sheave and the contact point with the elevator cab 12.

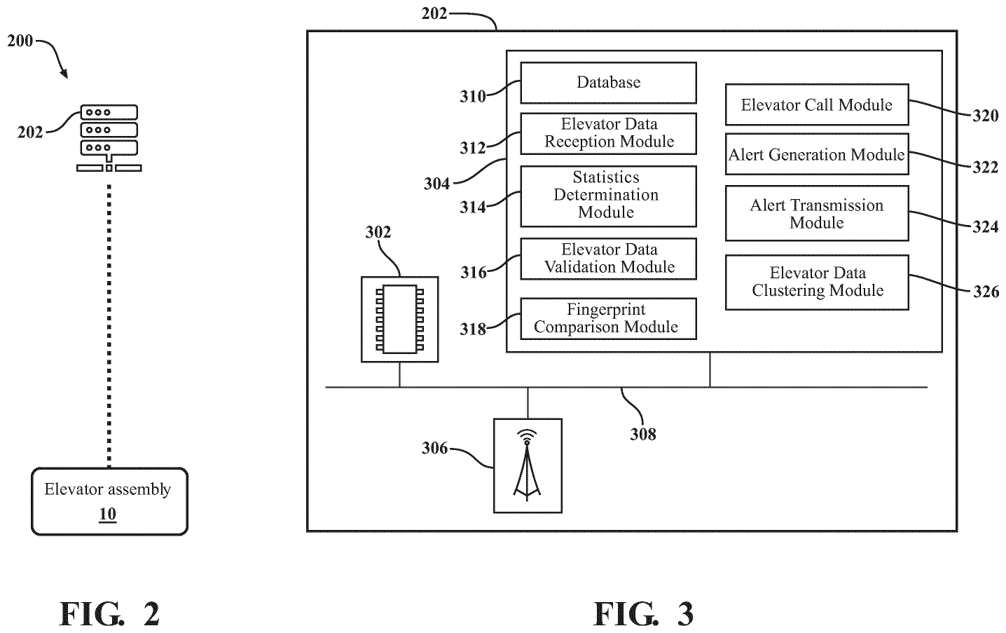

Referring now to FIG. 2, a fingerprint alert system 200 is shown. The fingerprint alert system 200 includes a remote computing device 202 and the elevator assembly 10 of FIG. 1A. However, in some examples, the fingerprint alert system 200 may include the elevator assembly 10′ of FIG. 1B instead of the elevator assembly 10 of FIG. 1A, and/or other elevator assemblies not illustrated. The remote computing device 202 may be communicatively coupled to the elevator assembly 10. In particular, the remote computing device 202 may be communicatively coupled to the network interface hardware 50 of FIG. 1A. In the illustrated example, the remote computing device 202 includes a cloud computing server. However, in other examples, the remote computing device 202 may be any other type of computing system. In the illustrated example, the remote computing device 202 is located remotely from the elevator assembly 10. However, in other examples, the remote computing device 202 may be located in the same location as the elevator assembly 10 (e.g., in the same building as the elevator assembly 10). The remote computing device 202 is described in further detail below.

Now referring to FIG. 3, the remote computing device 202 is schematically depicted. In the example of FIG. 3, the remote computing device 202 includes one or more processors 302, one or more memory modules 304, network interface hardware 306, and a communication path 308. The one or more processors 302 may be a controller, an integrated circuit, a microchip, a computer, a central processing unit (CPU), or any other computing device. The one or more memory modules 304 may include RAM, ROM, flash memories, hard drives, or any device capable of storing machine readable and executable instructions such that the machine readable and executable instructions can be accessed by the one or more processors 302.

The network interface hardware 306 can be communicatively coupled to the communication path 308 and can be any device capable of transmitting and/or receiving data via a network. Accordingly, the network interface hardware 306 can include a communication transceiver for sending and/or receiving any wired or wireless communication. For example, the network interface hardware 306 may include an antenna, a modem, LAN port, Wi-Fi card, WiMax card, mobile communications hardware, near-field communication hardware, satellite communication hardware and/or any wired or wireless hardware for communicating with other networks and/or devices. The network interface hardware 306 of the remote computing device 202 may transmit data to and receive data from the elevator assembly 10. For example, the network interface hardware 306 of the remote computing device 202 may be communicatively coupled to the network interface hardware 50 of the elevator assembly 10.

The one or more memory modules 304 include a database 310, an elevator data reception module 312, a statistics determination module 314, an elevator data validation module 316, a fingerprint comparison module 318, an elevator call module 320, an alert generation module 322, an alert transmission module 324, and an elevator data clustering module 326. Each of the database 310, the elevator data reception module 312, the statistics determination module 314, the elevator data validation module 316, the fingerprint comparison module 318, the elevator call module 320, an alert generation module 322, the alert transmission module 324, and the elevator data clustering module 326 may be a program module in the form of operating systems, application program modules, and other program modules stored in the one or more memory modules 304 (e.g., each of which may be embodied as a computer program, firmware, or hardware, as an example). In some embodiments, the program module may be stored in a remote storage device that may communicate with the remote computing device 202. Such a program module may include, but is not limited to, routines, subroutines, programs, objects, components, data structures and the like for performing specific tasks or executing specific data types as will be described below.

The database 310 may store data associated with fingerprint alerts, as disclosed herein. As discussed above, an elevator may experience errors that are not immediately recognized as errors by sensors or other error detection equipment associated with the elevator. However, certain patterns of behavior may be indicative of the elevator being in an error state. As such, in embodiments, fingerprint alerts may be used to identify elevator errors.

In embodiments, subject matter experts may determine patterns of behavior that are associated with an elevator experiencing an error. As disclosed herein, an elevator experiencing an error may include a malfunction of one or more components of an elevator, or a degradation of one or more components of an elevator. Some errors may be considered undesirable, and require immediate attention from a technician. Other errors may be considered more routine or minor, and may simply need to be monitored during a scheduled maintenance visits. Undesirable and routine or minor errors are discussed in further detail below.

A subject matter expert may determine patterns of behavior that are associated with an error using a variety of techniques. In some examples, a subject matter expert may use their experience to generate patterns of behavior that indicate an elevator error. In other examples, a subject matter expert may be notified that an error has occurred in an elevator (e.g., after inspection during a scheduled maintenance visit), and may then analyze elevator data leading up to the error. If multiple elevators experience similar behavior before an error occurs, the subject matter expert may determine that the associated behavior is indicative of an error.

In some examples, the remote computing device 202 or another computing device may analyze elevator data to identify behavior that may be indicative of an error. In some embodiments, subject matter experts may then review the identified behavior to verify that such behavior should be associated with an error. In other embodiments, machine learning techniques may be utilized. Once a pattern of behavior has been identified as indicating an elevator error, the pattern of behavior may be codified as a fingerprint. In some examples, a fingerprint may include a specific series of elevator actions (e.g., the elevator car 12 (FIG. 1A) performing multiple trips to different floors without the at least one elevator door 36 opening). In other examples, a fingerprint may include one or more statistics associated with an elevator car 12 (FIG. 1A) (e.g., the at least one elevator door 36 opening and closing more than a predetermined number of times without the elevator car 12 (FIG. 1A) moving to a different floor). Once a fingerprint has been codified, it may be stored in the database 310.

In addition to identifying a statistic of sequence of elevator actions that indicate an error, a fingerprint may also indicate a specific type of error indicated by the associated pattern of behavior. In embodiments, types of errors that may be indicated by a fingerprint may include traction relevel, hydraulic relevel, excess door movement, relevel at terminal, communication toggle, bad detector edge, DPRAM warning, dispatch communication, door disconnect, emergency phone line, jack resync warning, leak alert, MC1 contractor warning, over temperature warning, power issue, rope tension, valve alerts, false inspection mode activated, brake switch, elevator rocking download limit, elevator rocking upward limit, automatic rescue battery fault, releveling fault, automatic rescue inverter fault, failure on closing door, incorrect contactor sequence, 24 volt monitoring fault, lost position, EEPROM failure, safety string opened during trip, CAN bus issues, door locking failure, door unusual movement, relevel alert, over temperature door operator, lost position, and ZSE warning. In some examples, fingerprint alerts may be used for devices other than elevators (e.g., escalators). For an escalator, fingerprint alerts may indicate errors including left hand rail, right hand rail, excessive stopping distance, low oil, and recurring fault patterns.

In embodiments, a fingerprint may also indicate whether an error is an undesirable error that may result in an undesirable failure or shutdown of the elevator assembly 10 (FIG. 1A) or a minor or routine error (which may be referred to herein as a maintenance error). The undesirable error may indicate that immediate attention should be taken to address the error and this may trigger an undesirable alert, as discussed in greater detail herein. A maintenance error may indicate that the error is not as urgent and may be addressed during the next scheduled maintenance visits and thus may trigger a maintenance alert, as discussed in greater detail herein. As such, undesirable errors and maintenance errors may generate different types of alerts, as discussed in further detail below. In some examples, a fingerprint may also identify a specific elevator component that is likely causing the error. Further, the systems and methods described herein may validate the error and then alert or dispatch a technician. This may allow the technician to be alerted and dispatched to repair or replace the faulty component that is actually faulty.

In embodiments, one or more elevator alert fingerprints may be stored in the database 310. In particular, each fingerprint stored in the database 310 may indicate a pattern of behavior (e.g., a sequence of elevator actions or one or more elevator data statistics), and whether the associated error is an undesirable error or routine or a maintenance error. In some examples, the database 310 may also store a specific error or type of error associated with a fingerprint. In some examples, the database 310 may also store a component that is likely causing a particular error. In the illustrated example, the database 310 may also store elevator data validation parameters used by the elevator data validation module 316, as discussed in further detail below.

Referring still to FIG. 3, the elevator data reception module 312 may receive data from the elevator car 12 (FIG. 1A) or from other components of the elevator assembly 10 (FIG. 1A). In the illustrated example, the elevator data reception module 312 may receive elevator data from the network interface hardware 50 that has been received from the elevator controller 40. The data received by the elevator data reception module 312 may indicate actions or operations performed by the elevator cab 12 and/or the elevator assembly 10 during a predetermined interval of time. As discussed above, the data received by the elevator data reception module 312 may include data about elevator calls, opening and closing of the at least one elevator door 36, movement of an elevator between floors, speeds of the elevator doors while opening and closing, speeds of the elevator while moving between floors, alerts generated by one or more elevator sensors (e.g., the one or more sensors 38, the plurality of additional sensors 34, and the like), and other data associated with elevator operation.

In the illustrated example, the elevator data reception module 312 may receive elevator data in 10-minute intervals. That is, the elevator data reception module 312 may receive a series of data set transmissions from the network interface hardware 50, wherein each transmission indicates elevator actions performed during a 10-minute interval. In other examples, the elevator data reception module 312 may receive elevator data in other intervals of time. For example, the intervals may be discrete and may be less than or greater than 10 minutes. In other embodiments, the elevator data may be continuously received. The elevator data received by the elevator data reception module 312 may be stored in the database 310.

Referring still to FIG. 3, the statistics determination module 314 may determine statistics associated with the data received by the elevator data reception module 312. The statistics determined by the statistics determination module 314 may include a number of times that a particular elevator action was performed within a particular time period (e.g., the number of times that the elevator doors opened during a 10-minute interval), a ratio between the number of times that two different actions were performed within a particular time period (e.g., a ratio between the number of times the elevator doors opened and the number of trips the elevator took between different floors), as well as other statistical quantities associated with elevator data. In embodiments, the statistics determined by the statistics determination module 314 may be used by the elevator data validation module 316 and/or the fingerprint comparison module 318 as discussed below. As such, in the illustrated example, the statistics determination module 314 may determine statistics that are used by the elevator data validation module 316 and/or the fingerprint comparison module 318.

Referring still to FIG. 3, the elevator data validation module 316 may validate the data received by the elevator data reception module 312, as disclosed herein. As data is received by the elevator data reception module 312, it is possible that some of the data is not valid. For example, it is possible that the elevator controller 40 of the elevator assembly 10 received incorrect data from one or more sensors (e.g., from the plurality of additional sensors 34, the one or more sensors 38, and the like) of the elevator assembly 10. It is also possible that there was an error in data transmission between the elevator controller 40 and the network interface hardware 50 or between the network interface hardware 50 and the remote computing device 202. If either of these occurs, and the remote computing device 202 looks for fingerprint errors using invalid data, the remote computing device 202 may incorrectly identify an error that does not actually exist, identify the wrong type of error, or fail to identify an error that does exist. As such, the elevator data validation module 316 may validate the data received by the elevator data reception module 312, as disclosed herein.

In embodiments, the database 310 may store elevator data validation parameters that may be used to validate the received elevator data. The elevator data validation parameters may include ranges or thresholds that elevator data should satisfy to be considered valid. In particular, the elevator data validation parameters may specify ranges or thresholds outside of which elevator operation is not feasible. In the illustrated example, subject matter experts and/or machine learning may determine ranges or thresholds which are considered feasible for elevator operation to occur. The subject matter experts and/or machine learning may determine particular ranges of elevator data which are considered not physically possible, or extremely unlikely, which may indicate an error in the data.

In one example, a validation parameter may include a maximum feasible of elevator movement. For example, if elevator data indicates that an elevator car 12 (FIG. 1A) is moving faster than 200 miles per hour, then the data may be considered invalid. In another example, a validation parameter may include a maximum number of times that the at least one elevator door 36 may feasibly open and close during a short period of time. For example, if elevator data indicates that the at least one elevator door 36 opened and closed more than 10 times in one second, the data may be considered invalid. While these two example validation parameters are presented for purposes of illustration, it should be understood that other validation parameters may be used as well and/or there may be a plurality of validation parameters in which one or more may be used. The validation parameters may include any ranges of thresholds associated with any type of elevator data as may be determined by the subject matter experts and/or machine learning. As discussed above, the validation parameters may be stored in the database 310.

In embodiments, the elevator data validation module 316 may determine whether the data received by the elevator data reception module 312 satisfies each of the validation parameters stored in the database 310. In particular, the elevator data validation module 316 may compare the appropriate statistics determined by the statistics determination module 314 to statistics associated with each of the validation parameters stored in the database 310. The elevator data validation module 316 may determine whether the statistics associated with the elevator data, as determined by the statistics determination module 314, fit within allowed ranges specified by the validation parameters. If data received by the elevator data reception module 312 satisfies each of the validation parameters stored in the database 310, then the elevator data validation module 316 may determine that the data is valid. However, if data received by the elevator data reception module 312 does not satisfy all of the validation parameters stored in the database 310, then the elevator data validation module 316 may determine that the data is not valid. In the illustrated example, the elevator data validation module 316 may determine whether each data set received by the elevator data reception module 312 is valid (e.g., each 10-minute interval of data).

Referring still to FIG. 3, the fingerprint comparison module 318 may determine whether data received by the elevator data reception module 312 indicates a fingerprint error by determining whether the elevator data satisfies one or more of the fingerprints or error conditions specified by the fingerprints, as disclosed herein. As discussed above, the database 310 may store a plurality of fingerprints indicating elevator behavior that may indicate that an error has occurred. As such, the fingerprint comparison module 318 may compare data received by the elevator data reception module 312 to the fingerprints stored in the database 310. In particular, for fingerprints that include one or more statistics, the fingerprint comparison module 318 may compare the appropriate statistics determined by the statistics determination module 314 to the statistics of the fingerprint. For example, the fingerprint comparison module 318 may determine whether particular statistics fall within a particular range specified by a fingerprint. For fingerprints that include a particular sequence of elevator actions, the fingerprint comparison module 318 may determine whether data received by the elevator data reception module 312 contains the sequence of actions specified by the fingerprint. If the fingerprint comparison module 318 determines a match between received elevator data and a fingerprint, the fingerprint comparison module 318 may determine that an error has occurred at the elevator associated with the received data.

In the illustrated example, the fingerprint comparison module 318 compares data within one data set (e.g., covering a 10-minute interval) to fingerprints stored in the database 310. However, in other examples, the fingerprint comparison module 318 may compare data of multiple data sets to fingerprints stored in the database 310. For example, certain fingerprints may comprise statistics based on data covering a longer period of time than the data from one data set (e.g., a fingerprint may include statistics generated over a 24-hour period). As such, the fingerprint comparison module 318 may compare an amount of data appropriate for a particular fingerprint.

Referring still to FIG. 3, the elevator call module 320 may transmit a call to the elevator car 12 (FIG. 1A) for which an error has been identified by the fingerprint comparison module 318 in order to determine whether the elevator car 12 (FIG. 1A) is functioning. As discussed above, the fingerprint comparison module 318 may determine whether elevator data received by the elevator data reception module 312 matches a fingerprint stored in the database 310, thereby indicating that the elevator car 12 (FIG. 1A) or other component of the elevator assembly 10 (FIG. 1A) may be experiencing an error. However, in order to verify whether the elevator car 12 (FIG. 1A) or other component of the elevator assembly 10 (FIG. 1A) is actually experiencing an error, the elevator call module 320 may send a signal to the elevator controller 40 to cause the elevator car 12 (FIG. 1A) for which an error is indicated to move to a particular floor. The elevator call module 320 may then remotely monitor the response of the elevator car 12 (FIG. 1A) to determine how the elevator car 12 (FIG. 1A) responds to the elevator call.

If the affected elevator car 12 (FIG. 1A) responds to the elevator call by moving to another floor as specified in the elevator call, then the elevator call module 320 may determine that the elevator car 12 (FIG. 1A) or other component of the elevator assembly 10 (FIG. 1A) is not actually experiencing an error. However, if the elevator car 12 (FIG. 1A) does not properly respond to the elevator call, then the elevator call module 320 may confirm that the elevator car 12 (FIG. 1A) or other component of the elevator assembly 10 (FIG. 1A) is actually experiencing an error. In some examples, the elevator call module 320 may transmit a signal to the elevator to cause the elevator assembly 10 to perform an automatic inspection or to remotely reset the elevator controller 40.

Referring still to FIG. 3, the alert generation module 322 may generate an alert when the fingerprint comparison module 318 determines that the elevator car 12 (FIG. 1A) or other component of the elevator assembly 10 (FIG. 1A) is experiencing an error and the elevator call module 320 confirms the error. In some examples, the elevator call module 320 may be omitted and the alert generation module 322 may generate an alert when the fingerprint comparison module 318 identifies an error without confirmation by the elevator call module 320.

In the illustrated example, when the fingerprint comparison module 318 identifies an error that is confirmed by the elevator call module 320, the alert generation module 322 may determine the type of error associated with the error identified by the fingerprint comparison module 318. As discussed above, the database 310 may store fingerprints along with the type of error associated with each fingerprint. As such, the alert generation module 322 may access the database 310 to determine the type of error associated with the fingerprint matched by the fingerprint comparison module 318. In the illustrated example, the alert generation module 322 may determine whether an identified alert is an undesirable alert or a maintenance alert. However, in other examples, the alert generation module 322 may identify other types of errors associated with matched fingerprints. The alert generation module 322 may then generate an alert to be transmitted. For example, an alert generated by the alert generation module 322 may include text, images, or other information to convey information associated with the alert and to dispatch the technician when the error is the undesirable error. In particular, the alert generation module 322 may generate an alert that identifies the particular elevator car 12 (FIG. 1A) for which an error has been found, and whether the error is an undesirable error or a maintenance error. In some examples, the generated alert may also identify the specific component that has likely caused the error.

Referring still to FIG. 3, the alert transmission module 324 may transmit an alert generated by the alert generation module 322. The alert transmission module 324 may transmit the alert to the owner or operator of the elevator assembly 10 (FIG. 1A) undergoing the error. In some examples, the alert transmission module 324 may also transmit the alert to a system that manages the remote computing device 202. This may allow for analysis of the fingerprints and associated errors in order to determine if any of the fingerprints should be modified. In some examples, the alert transmission module 324 may transmit the alert to a technician. As such, if the alert is an undesirable alert for the undesirable error, the technician may make an unscheduled visit to service the elevator. And if the alert is a maintenance alert, the technician may check on the affected component during the next scheduled maintenance visit for the elevator.

Referring still to FIG. 3, the elevator data clustering module 326 may be used to assist subject matter experts/machine learning in determining fingerprints for elevator errors. In embodiments, the elevator data clustering module 326 may receive historical elevator data. For example, the elevator data clustering module 326 may receive elevator data for one or more elevator cars 12 (FIG. 1A) or other component of the elevator assembly 10 (FIG. 1A) over a period of weeks, months, or years. The elevator data clustering module 326 may also receive data indicating when each of those elevators experienced errors. In some of these examples, these errors may be identified during maintenance visits. In other examples, these errors may be identified in other ways.

After receiving elevator data and identified errors, the elevator data clustering module 326 may analyze elevator data associated with elevators shortly before an error occurred (e.g., during a 10-minute period before the error occurred) and perform clustering analysis on this data (e.g., K-means or other types of clustering analysis). In particular, the elevator data clustering module 326 may identify unusual data clusters that appear shortly before an error is identified. The identified data clusters may be further analyzed by subject matter experts to determine if the identified data cluster should be used as part of a fingerprint to identify an error.

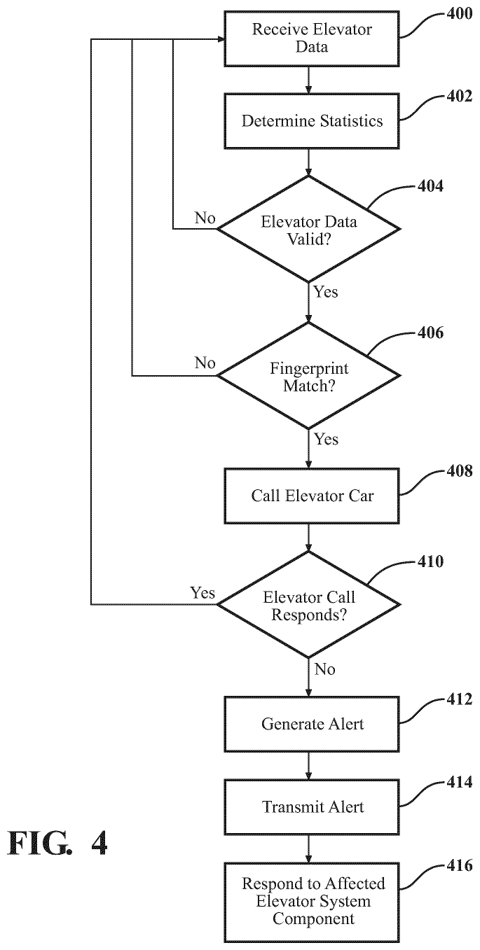

Turning now to FIG. 4, a flow chart is depicted of an example method that may be performed by the remote computing device 202. Although the steps associated with the blocks of FIG. 4 will be described as being separate tasks, in other embodiments, the blocks may be combined or omitted. Further, while the steps associated with the blocks of FIG. 4 will described as being performed in a particular order, in other embodiments, the steps may be performed in a different order.

At step 400, the elevator data reception module 312 receives elevator data. In particular, the elevator data reception module 312 may receive elevator data from the network interface hardware 50 of the elevator assembly 10.

At step 402, the statistics determination module 314 determines statistics associated with the elevator data received by the elevator data reception module 312. In particular, the statistics determination module 314 may determine statistics utilized by the elevator data validation module 316 and/or the fingerprint comparison module 318.

At step 404, the elevator data validation module 316 determines whether the elevator data received by the elevator data reception module 312 is valid. In particular, the elevator data validation module 316 may compare the statistics determined by the statistics determination module 314 to the validation parameters stored in the database 310. If the determined statistics are within the ranges specified by the validation parameters, the elevator data validation module 316 may determine that the elevator data is valid. If the determined statistics are outside of the ranges specified by the validation parameters, the elevator data validation module 316 may determine that the elevator data is not valid. If the elevator data validation module 316 determines that the elevator data is not valid (NO at step 404), then control returns to step 400. If the elevator data validation module 316 determines that the elevator data is valid (YES at step 404), then control passes to step 406.

At step 406, the fingerprint comparison module 318 compares the elevator data received by the elevator data reception module 312 to the fingerprints stored in the database 310 and determines whether the elevator data matches any of the fingerprints. In particular, the fingerprint comparison module 318 may determine whether data matches statistics determined by the statistics determination module 314 matches the statistics associated with any fingerprints or whether any sequence of elevator actions within the elevator data matches a sequence associated with any fingerprints. If the fingerprint comparison module 318 determines that the elevator data does not match any fingerprints (NO at step 406), then control returns to step 400. If the fingerprint comparison module 318 determines that the elevator data matches one or more fingerprints, then it is determined that an error has occurred with respect to the elevator car associated with the elevator data and control passes to step 408.

At step 408, the elevator call module 320 transmits a signal to the elevator car associated with the determined error to cause the elevator car 12 (FIG. 1A) to move to another floor. Then, at step 410, the elevator call module 320 determines whether the elevator car 12 (FIG. 1A) has responded to the elevator call by moving to the specified floor. If the elevator call module 320 determines that the elevator car 12 (FIG. 1A) has responded to the elevator call by moving to the specified floor (YES at step 410), then control returns to step 400. If the elevator call module 320 determines that the elevator car 12 (FIG. 1A) has not responded to the elevator call by moving to the specified floor (NO at step 410), then control passes to step 412. As such, the elevator call module 320 may be a diagnostic tool to confirm whether there is a legitimate error in the elevator assembly 10 (FIG. 1A) or whether the error is erroneous.

At step 412, the alert generation module 322 generates an alert associated with the determined error. In particular, the alert generation module 322 identifies the elevator car for which the error has occurred and identifies whether the error is an undesirable error or a maintenance error based on data associated with the fingerprint that was matched to the elevator data. In some examples, the alert generation module 322 may also determine a particular elevator component causing the error based on the fingerprint alert data. The alert generation module 322 then generates an alert and/or dispatch that includes the information about which elevator car 12 and/or component of the elevator assembly 10 is suffering the alert and the type of alert. Then, at step 414, the alert transmission module 324 transmits the generated alert and/or dispatch to an owner, responsible party, or operator of the affected elevator. In some examples, the alert transmission module 324 may also transmit the generated alert to other parties. Upon receiving the alert, at step 416, the technician associated with the elevator system (e.g., repair technician) is dispatched and responds to the elevator assembly 10 (FIG. 1A) based on the type of alert generated.

It should now be understood that embodiments disclosed herein provide fingerprint alerts for elevators. The embodiments disclosed herein allow for the detection of errors based on elevator behavior. In embodiments, a large amount of elevator data may be analyzed in real-time and alerts may be sent to the appropriate parties when an error is identified. Furthermore, embodiments may determine whether the error is an undesirable error, requiring immediate attention from the technician.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A computing device comprising one or more processors configured to:
receive elevator data comprising a series of actions performed by an elevator car during a predetermined period of time;
determine whether the elevator data satisfies one or more error conditions; and
upon determination that the elevator data satisfies one or more of the error conditions, transmit an alert to a technician associated with the elevator car.

2. The computing device of claim 1, wherein the one or more processors are further configured to:
determine whether the elevator data satisfies each of one or more validation parameters; and
upon determination that the elevator data satisfies each of the one or more validation parameters, determine whether the elevator data satisfies the one or more error conditions.

3. The computing device of claim 2, wherein the one or more processors are further configured to:
after receiving the elevator data, determine statistics associated with the elevator data; and
determine whether the elevator data satisfies each of the one or more validation parameters based on the statistics.

4. The computing device of claim 1, wherein the one or more processors are further configured to:
upon determination that the elevator data satisfies one or more of the error conditions, transmit a signal to the elevator car to cause the elevator car to move to a specified floor;
determine whether the elevator car moves to the specified floor; and
upon determination that the elevator car does not move to the specified floor, transmit the alert to the technician.

5. The computing device of claim 1, wherein the one or more processors are further configured to:
upon determination that the elevator data satisfies one or more of the error conditions, determine whether the error condition that was satisfied is associated with an undesirable alert or a maintenance alert; and
transmit the alert to the technician, wherein the alert specifies whether the satisfied error condition is associated with the undesirable alert or the maintenance alert.

6. The computing device of claim 1, wherein the one or more processors are configured to:
determine first statistics associated with the elevator data; and
determine whether the elevator data satisfies one or more of the error conditions based upon the first statistics and second statistics associated with the one or more error conditions.

7. The computing device of claim 1, wherein the one or more processors are configured to determine whether the elevator data satisfies one or more of the error conditions by determining whether a sequence of actions within the elevator data matches a sequence of actions associated with any of the one or more error conditions.

8. A method comprising:
receiving elevator data comprising a series of actions performed by an elevator car during a predetermined period of time;
determining whether an elevator data satisfies one or more error conditions; and
upon determination that the elevator data satisfies one or more of the error conditions, transmitting an alert to a technician associated with the elevator car.

9. The method of claim 8, further comprising:
determining whether the elevator data satisfies each of one or more validation parameters; and
upon determination that the elevator data satisfies each of the one or more validation parameters, determining whether the elevator data satisfies the one or more error conditions.

10. The method of claim 9, further comprising:
after receiving the elevator data, determining statistics associated with the elevator data; and
determining whether the elevator data satisfies each of the one or more validation parameters based on the statistics.

11. The method claim 8, further comprising:
upon determination that the elevator data satisfies one or more of the error conditions, transmitting a signal to the elevator car to cause the elevator car to move to a specified floor;
determining whether the elevator car moves to the specified floor; and
upon determination that the elevator car does not move to the specified floor, transmitting the alert to the technician.

12. The method of claim 8, further comprising:
upon determination that the elevator data satisfies one or more of the error conditions, determining whether the error condition that was satisfied is associated with an undesirable alert or a maintenance alert; and
transmitting the alert to the technician, wherein the alert specifies whether the satisfied error condition is associated with the undesirable alert or the maintenance alert.

13. The method of claim 8, further comprising:
determining first statistics associated with the elevator data; and
determining whether the elevator data satisfies one or more of the error conditions based upon the first statistics and second statistics associated with the one or more error conditions.

14. The method of claim 8, further comprising determining whether the elevator data satisfies one or more of the error conditions by determining whether a sequence of actions within the elevator data matches a sequence of actions associated with any of the one or more error conditions.

15. A system comprising:
an elevator assembly; and
a remote computing device;
wherein the elevator assembly comprises:
an elevator car;
an elevator controller configured to control operation of the elevator car; and
a transceiver configured to transmit elevator data comprising a series of actions performed by the elevator car during a predetermined period of time to the remote computing device; and
wherein the remote computing device comprises one or more processors configured to:
receive the elevator data;
determine whether the elevator data satisfies one or more error conditions; and
upon determination that the elevator data satisfies one or more of the error conditions, transmit an alert to a technician associated with the elevator assembly.

16. The system of claim 15, wherein the one or more processors is further configured to:
determine whether the elevator data satisfies each of one or more validation parameters; and
upon determination that the elevator data satisfies each of the one or more validation parameters, determine whether the elevator data satisfies the one or more error conditions.

17. The system of claim 15, wherein the one or more processors is further configured to:
upon determination that the elevator data satisfies one or more of the error conditions, transmit a signal to the elevator assembly to cause the elevator car to move to a specified floor;
determine whether the elevator car moves to the specified floor; and
upon determination that the elevator car does not move to the specified floor, transmit the alert to the technician.

18. The system of claim 15, wherein the one or more processors is further configured to:
upon determination that the elevator data satisfies one or more of the error conditions, determine whether the error condition that was satisfied is associated with an undesirable alert or a maintenance alert; and
transmit the alert to the technician, wherein the alert specifies whether the satisfied error condition is associated with the undesirable alert or the maintenance alert.

19. The system of claim 15, wherein the one or more processors is configured to:
determine first statistics associated with the elevator data; and
determine whether the elevator data satisfies one or more of the error conditions based upon the first statistics and second statistics associated with the one or more error conditions.

20. The system of claim 15, wherein the one or more processors is configured to determine whether the elevator data satisfies one or more of the error conditions by determining whether a sequence of actions within the elevator data matches a sequence of actions associated with any of the one or more error conditions.
